(19) United States
(12) Patent Application Publication
(10) Pub. No.: US 2018/0366253 A1
(43) Pub. Date: Dec. 20, 2018

(54) METHODS AND APPARATUS FOR SHIELDING IN WIRELESS TRANSFER POWER SYSTEMS

(71) Applicant: QUALCOMM Incorporated, San Diego, CA (US)

(72) Inventors: Leandro Alberto Percebon, Munich (DE); Simon Islinger, Munich (DE)

(21) Appl. No.: 16/009,063

(22) Filed: Jun. 14, 2018

Related U.S. Application Data
(60) Provisional application No. 62/520,461, filed on Jun. 15, 2017.

(51) Int. Cl. H01F 27/28; B60L 11/18; H01F 27/24; H01F 41/02; H01F 27/02

(52) U.S. Cl. CPC H01F 27/28; B60L 11/182; B60L 2210/30; H01F 41/02; H01F 27/02; H01F 27/24

(57) ABSTRACT

Aspects of this disclosure include an apparatus configured to and methods for the transfer of wireless power. The apparatus comprises a first coil configured to generate a magnetic field over a charging area, the first coil forming a coil area. The apparatus further comprise a ferrite material positioned in contact with or next to the first coil. The ferrite material has a ferrite footprint forming a two-dimensional area, the two-dimensional area at least partially overlapping the coil area. The apparatus further comprise a metallic plate positioned in contact or next to the ferrite material. The metallic plate has a plate footprint forming an area that is substantially equal to the two-dimensional area of the ferrite footprint.

### CROSS-REFERENCE TO RELATED APPLICATIONS

This application claims the benefit of priority to U.S. Provisional Appl. No. 62/520,461, filed Jun. 15, 2017, which is incorporated in its entirety by reference herein.

### FIELD

The present disclosure relates generally to wireless power transfer, and more specifically to devices, systems, and methods related to wireless power transfer to remote systems such as electric vehicles (EV) using various antenna or coil topologies.

### BACKGROUND

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via a wireless field) to be used to charge electric vehicles may overcome some of the deficiencies of wired charging solutions. As such, wireless charging systems and methods that efficiently and safely transfer power for charging electric vehicles are desired.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

An aspect disclosed herein provides an apparatus for wireless power transfer. The apparatus comprises a first coil configured to generate a magnetic field over a charging area, the first coil forming a coil area. The apparatus further comprise a ferrite material positioned in contact with or next to the first coil. The ferrite material has a ferrite footprint forming a two-dimensional area, the two-dimensional area at least partially overlapping the coil area The apparatus further comprise a metallic plate positioned in contact or next to the ferrite material. The metallic plate has a plate footprint forming an area that is substantially equal to the two-dimensional area of the ferrite footprint.

Another aspect disclosed herein provides another apparatus for wireless power transfer. The apparatus comprises first means for generating a magnetic field over a charging area. The apparatus also comprises means for modifying the magnetic field positioned below the first means, the modifying means having a ferrite footprint forming a two-dimensional area. The apparatus further comprises means for supporting the means for modifying and the means for generating the magnetic field, the supporting means positioned below and substantially overlapping the ferrite material such that the ferrite material is positioned between and separating the first coil and the metallic plate, the metallic plate having a footprint forming an area that is substantially equal to the two-dimensional area of the ferrite footprint.

Another aspect disclosed herein provides a method of wireless power transfer. The method comprises generating a magnetic field over a charging area via a transmit antenna circuit. The method also comprises altering at least a portion of the magnetic field using a ferrite material positioned below at least a portion of the transmit antenna circuit, the ferrite material having a ferrite footprint forming a two-dimensional area. The method further comprises shielding components other than the transmit antenna circuit and the ferrite material from the magnetic field via a metallic plate positioned below and substantially overlapping the ferrite material such that the ferrite material is positioned between and separating the transmit antenna circuit and the metallic plate, the metallic plate having a footprint forming an area that is substantially equal to the two-dimensional area of the ferrite footprint.

An additional aspect comprises a method of forming an apparatus for wireless power transfer. The method comprises positioning a coil having a coil area and configured to generate a magnetic field over a charging area in contact with or next to a ferrite material, the ferrite material having a ferrite footprint forming a two-dimensional area, the two-dimensional area at least partially overlapping the coil area. The method also comprises positioning a metallic plate in contact with or next to the ferrite material, the metallic plate having a footprint forming an area that is substantially equal to and overlapping the two-dimensional area of the ferrite footprint.

### BRIEF DESCRIPTION OF THE DRAWINGS

FIG. 1 is a functional block diagram of a wireless power transfer system, in accordance with some implementations.

FIG. 2 is a functional block diagram of a wireless power transfer system, in accordance with some implementations.

FIG. 3 is a schematic diagram of a portion of transmit circuitry or receive circuitry of

FIG. 2 including a transmit or receive coil, in accordance with some implementations.

FIG. 4 is a diagram of an exemplary wireless power transfer system for charging an electric vehicle, in accordance with some implementations.

FIGS. 5A-5C show various views of a vehicle pad as used in the wireless power transfer system of FIG. 4, the vehicle pad having a ferrite layer with a smaller footprint than a footprint of a non-conductive backplate of the vehicle pad, in accordance with one implementation.

FIGS. 6A-6C show various views of a vehicle pad as used in the wireless power transfer system of FIG. 4, the vehicle pad having a ferrite layer with a same footprint as a footprint of a non-conductive backplate of the vehicle pad, in accordance with one implementation.

FIG. 7 shows an exploded perspective view of the vehicle pad of FIGS. 6A-6C, in accordance with one implementation.

FIGS. 8A and 8B show a thermal image of the vehicle pad of FIGS. 5A-5C as compared to a thermal image of the vehicle pad of FIGS. 6A-6C, in accordance with one implementation.

FIG. 9 shows a flowchart for a method of transferring wireless power with the vehicle pad of FIGS. 6A-6C, in accordance with one implementation.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured, or coupled by a “power receiving element” to achieve power transfer.

The terminology used herein is for the purpose of describing particular implementations only and is not intended to be limiting on the disclosure. It will be understood that if a specific number of a claim element is intended, such intent will be explicitly recited in the claim, and in the absence of such recitation, no such intent is present. For example, as used herein, the singular forms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like). While the systems are described herein in relation to vehicle charging, any other wireless charging applications are contemplated for application of the systems described herein.

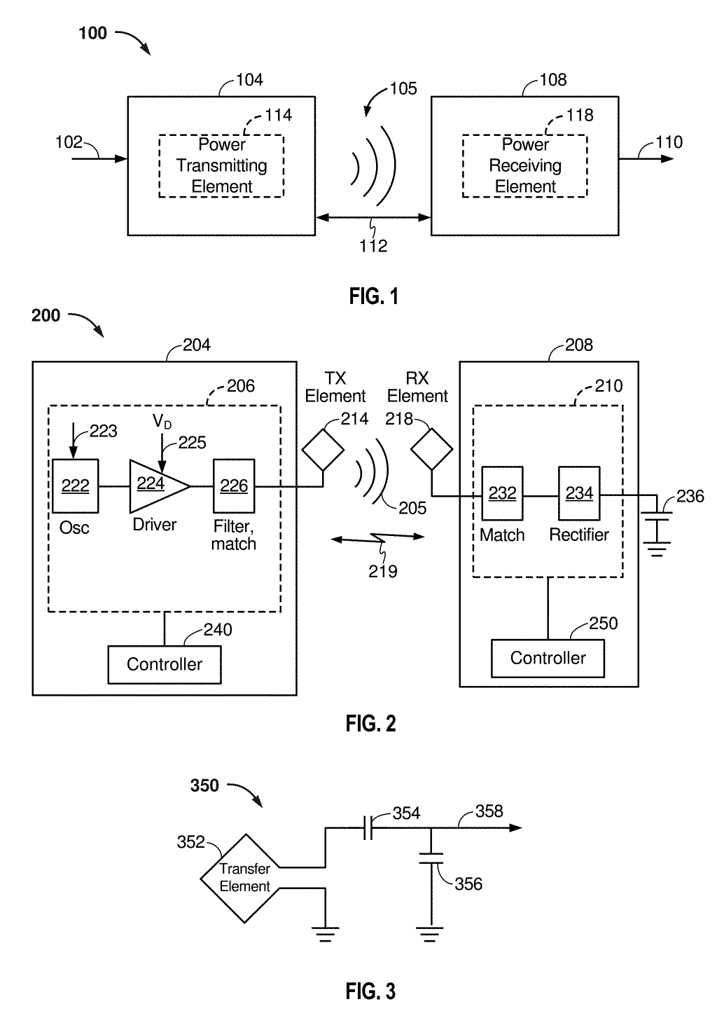

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a power transmitting element 114 for performing energy transfer. The receiver 108 may receive power when the receiver 108 is located in the wireless field 105 produced by the transmitter 104. The wireless field 105 corresponds to a region where energy output by the transmitter 104 may be captured by the receiver 108. A receiver 108 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the power transmitting element 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the power transmitting element 114 to the power receiving element 118, residing in the vicinity of the wireless field 105, rather than propagating the energy from the power transmitting element 114 into free space. Resonant inductive coupling techniques may thus allow for improved efficiency and power transfer over various distances and with a variety of inductive power transfer element configurations.

In some implementations, the wireless field 105 corresponds to the “near-field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114. Efficient energy transfer may occur by coupling a large portion of the energy in the wireless field 105 to the power receiving element 118 rather than propagating most of the energy in an electromagnetic wave to the far field. When positioned within the wireless field 105, a “coupling mode” may be developed between the power transmitting element 114 and the power receiving element 118.

FIG. 2 is a functional block diagram of a wireless power transfer system 200, in accordance with some other exemplary implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator circuit 222, a driver circuit 224, and a filter and matching circuit 226. The oscillator circuit 222 may be configured to generate a signal at a desired frequency that may be adjusted in response to a frequency control signal 223. The oscillator circuit 222 provides the oscillator signal to the driver circuit 224. The driver circuit 224 may be configured to drive the power transmitting element 214 at a resonant frequency of the power transmitting element 214 based on an input voltage signal (VD) 225. The driver circuit 224 may be a switching amplifier configured to receive a square wave from the oscillator 222 and output a sine wave.

The filter and matching circuit 226 filters out harmonics or other unwanted frequencies and matches the impedance of the transmit circuitry 206 to the power transmitting element 214. As a result of driving the power transmitting element 214, the power transmitting element 214 generates a wireless field 205 to wirelessly output power at a level sufficient for charging a battery 236 or otherwise powering a load.

The transmitter 204 further includes a controller circuit 240 operably coupled to the transmit circuitry 206 and configured to control one or more functions and operations of the transmit circuitry 206 or accomplish other operations relevant to managing a transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations and/or calculations performed by the controller 240. The transmitter 204 may further include a memory (not shown) configured to store data, for example, such as instructions for causing the controller 240 to perform particular functions, such as those related to management of wireless power transfer.

The receiver 208 comprises receive circuitry 210 that includes a matching circuit 232 and a rectifier circuit 234. The matching circuit 232 may match the impedance of the receive circuitry 210 to the impedance of the power receiving element 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236. Receiver 208 may directly couple to the wireless field 205 and may generate an output power for storing or consumption by a battery (or load) 236 coupled to the output or receive circuitry 210.

The receiver 208 may further include a controller circuit 250 configured similarly to the transmit controller 240 as described above for managing one or more functions and operations of the wireless power receiver. The receiver 208 may further include a memory (not shown) configured to store data, for example, such as instructions for causing the controller 250 to perform particular functions, such as those related to management of wireless power transfer.

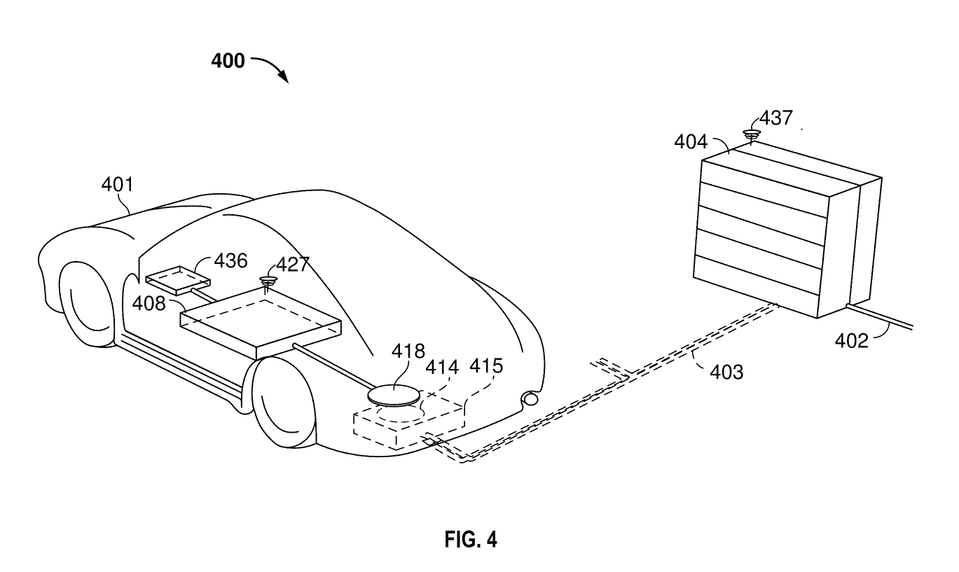

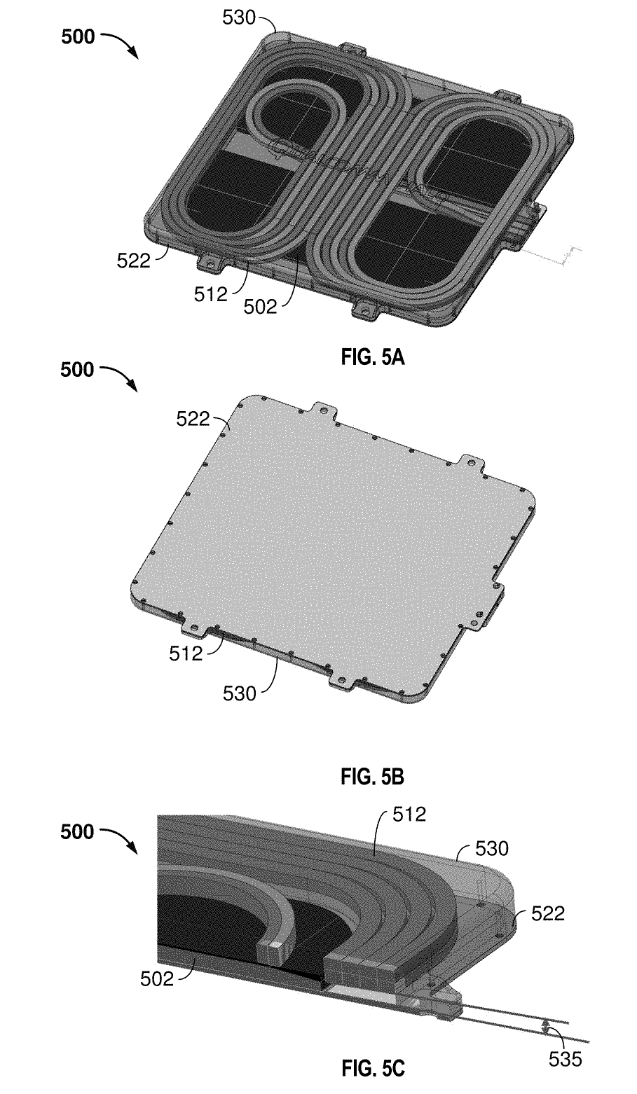

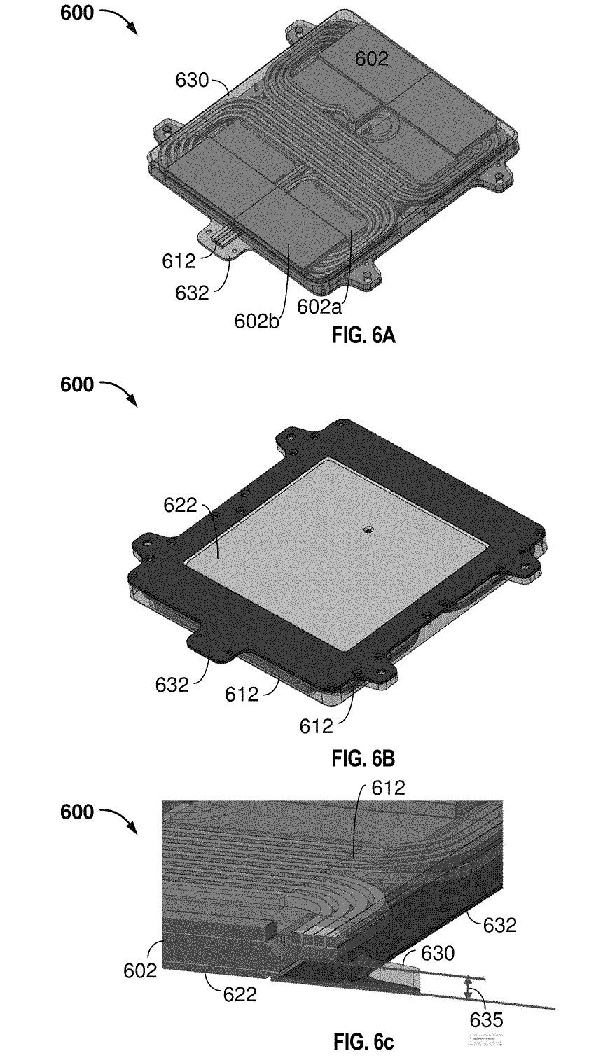

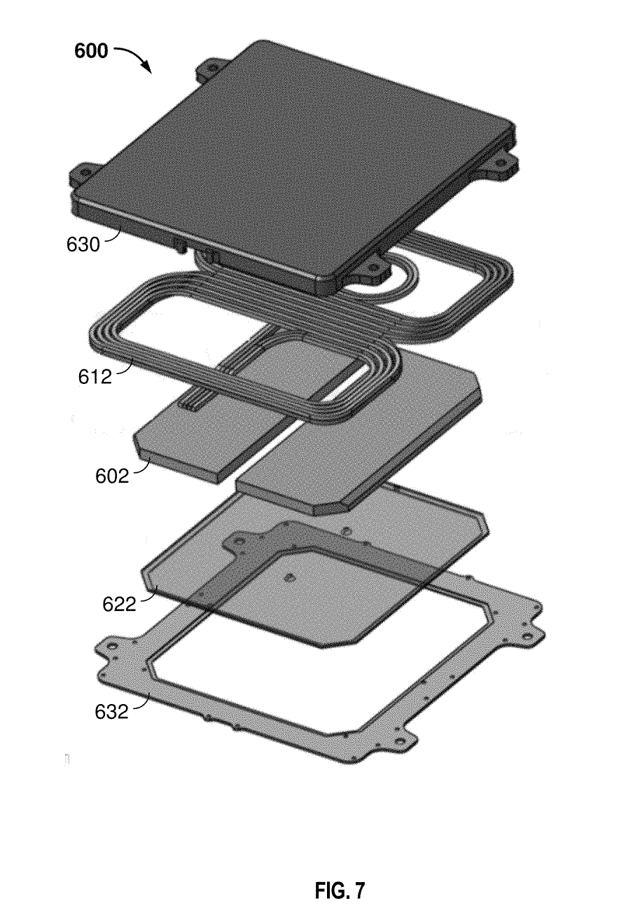

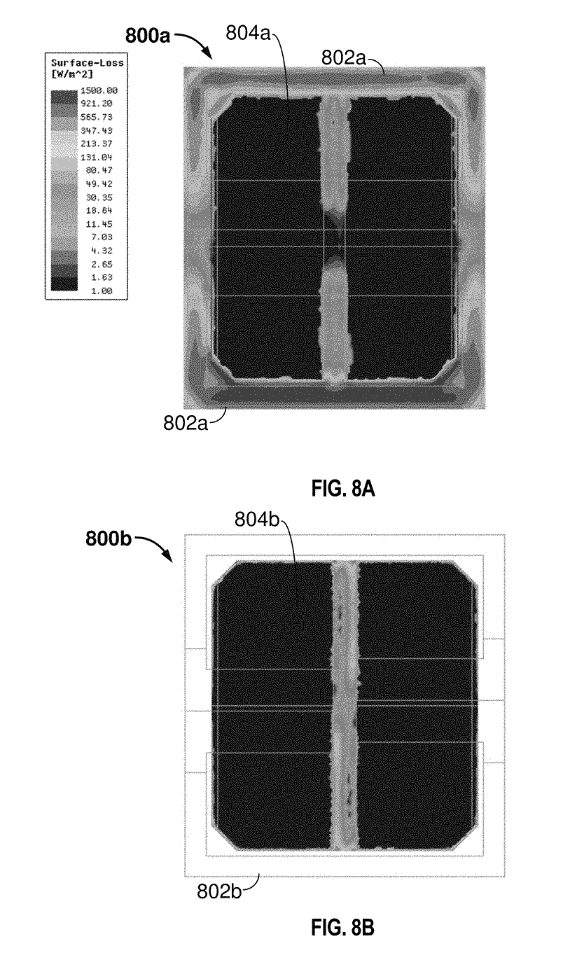

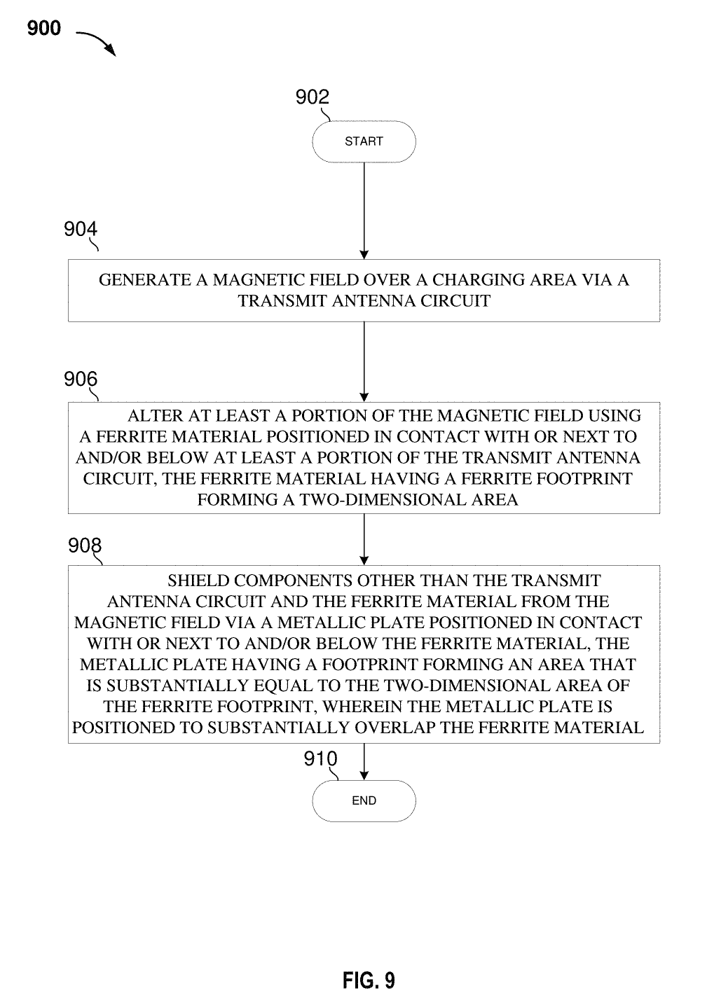

FIG. 3 is a schematic diagram of a portion of the transmit circuitry 206 or the receive circuitry 210 of FIG. 2, in accordance with some exemplary implementations. As illustrated in FIG. 3, transmit or receive circuitry 350 may include a power transfer element or 352. The power transfer element 352 may also be referred to or be configured as a “conductor or conductive loop”, a “coil”, an “inductor”, an “antenna”, or a “magnetic coupler”. The term “power transfer element” generally refers to a component that may wirelessly output or receive energy for coupling to another “power transfer element.”

The resonant frequency of the loop or magnetic power transfer elements is based on the inductance and capacitance of the loop or magnetic power transfer element. Inductance may be simply the inductance created by the power transfer element 352, whereas, capacitance may be added via a capacitor (or the self-capacitance of the power transfer element 352) to create a resonant structure at a desired resonant frequency. As a non-limiting example, a capacitor 354 and a capacitor 356 may be added to the transmit or receive circuitry 350 to create a resonant circuit that resonates at a resonant frequency. For power transmitting element, the signal 358, with a frequency that substantially corresponds to the resonant frequency of the power transmitting element 352, may be an input to the power transmitting element 352. For power receiving elements, the signal 358 may be an output to power or charge a load.

FIG. 4 is a diagram of an electrically chargeable vehicle 401 aligned over a wireless power transmitting element 414, in accordance with some implementations. The wireless power transfer system 400 enables charging of the vehicle 401 while the vehicle 401 is parked near the transmitter 404 that may include an antenna 437. Space is shown for the vehicle 401 to be parked over the power transmitting element 414. The power transmitting element 414 may be located within a base pad 415. In some implementations, the transmitter 404 may be connected to a power backbone 402. The transmitter 404 may be configured to provide an alternating current (AC), through an electrical connection 403, to the power transmitting element 414 located within the base pad 415. The vehicle 401 may include a battery 436, a power receiving element 418, and an antenna 427 each connected to the receiver 408.

In some implementations, the power receiving element 418 may receive power when the power receiving element 418 is located in a wireless (e.g., magnetic or electromagnetic) field produced by the power transmitting element 414. The wireless field corresponds to a region where energy output by the power transmitting element 414 may be captured by the power receiving element 418. In some cases, the wireless field may correspond to the “near field” of the power transmitting element 414.

It is desirable that the power receiving element 418 provides at least some minimum rated power to the receiver 408 in order to efficiently charge the battery 436 or power the vehicle 401. The minimum rated power may include additional electrical load requirements in addition to charging the battery 436, for example, any electrical requirements of one or more electronic devices within and powered by the vehicle 401.

In some implementations, power receiving elements may be unable to efficiently and effectively couple to both vertically polarized and horizontally polarized power transmitting elements. For example, a vertically polarized power transmitting element may generate a flux that is mostly in a vertical direction at the center of the power receiving element, while a horizontally polarized power transmitting element may generate a flux that is mostly in the horizontal direction at the center of the power receiving element. Thus, power receiving elements that are only able to couple to flux of a single direction may be inoperable or have reduced power transfer efficiency in relation to all types of power transmitting elements.

In some implementations, the vertical direction of flux from a power transmitting element may be described as a first component of a magnetic field generated by the power transmitting element. Similarly, a second component of the magnetic field may correspond to a horizontal direction of flux from the power transmitting element. Thus, the direction of flow of flux (horizontal or vertical) may define or correspond to horizontal or vertical flux components of the magnetic field.

Accordingly, power receiving elements that couple with both vertically and horizontally polarized power transmitting elements may enable interoperability with various configurations and types of power transmitting elements. Such power receiving elements may also improve tolerance of horizontal misalignment between the power receiving and transmitting elements, regardless of configuration, where the horizontal misalignment may impact polarization direction at the power receiving element.

FIGS. 5A-5C show various views of a pad 500 as used in the wireless power transfer system 400 of FIG. 4, the pad 500 having a ferrite layer 502 with a smaller footprint than a footprint of a backplate 522 of the pad 500, in accordance with one implementation. FIG. 5A includes a top perspective view of the pad 500, FIG. 5B includes a bottom perspective view of the pad 500, and FIG. 5C includes a partial cross-section view of the pad 500. The pad 500 includes the backplate 522, the ferrite layer 502, a coil 512, and a housing 530.

As shown in the top perspective view of FIG. 5A, the pad 500 (e.g., a vehicle pad) the coil 512 is disposed partially on top of and partially between the ferrite layer 502 and is enclosed within an enclosure created by the backplate 522 and the housing 530. The coil 512 may be wound about a solenoid or around a core (not shown) and may be mounted on or to the backplate 522. In some implementations, the backplate 522 may be conductive, while in some implementations, the backplate 522 may be non-conductive. As shown, the coil 512 is wound in a double-D (DD) configuration with varying coil thickness and width as formed by the windings. For example, the coil 512 is less thick but wider for the portions of the coil 512 disposed near a center of the pad 500 while thicker but less wide for the portions of the coil 512 disposed near edges of the pad 500. Other configurations of the coil 512 (e.g., quadrature (Q), QDD, etc.) may be implemented in the pad 500.

The ferrite layer 502 of the pad 500 may be positioned, at least in part, between the coil 512 and the backplate 522. In some embodiments, the coil 512 may have a coil area comprising an area encompassed or surrounded by the coil 512 and an area that conductor(s) of the coil 512 cover. One or more pieces of ferrite may form the ferrite layer 502. The ferrite layer 502 may have a ferrite area corresponding to a two-dimensional area covered by the ferrite layer 502. In some embodiments, the ferrite area may be substantially the same as the coil area. The backplate 522 is placed in contact with or next to the ferrite layer 502, so that the ferrite layer 502 is positioned between the coil 512 and the metallic backplate 522. The backplate 522 may have a backplate area corresponding to a two-dimensional area covered by the backplate 522. In some embodiments, the backplate area of the backplate 522 may be larger than the ferrite layer 502. Leads from the coil 512 may be fed under the windings of the coil 512 and may protrude from one edge of the pad 500.

As shown in the bottom perspective view of FIG. 5B, the backplate 522 is shown covering an entire bottom surface of the pad 500. The housing 530 is also shown aligned with the backplate 522 to create the enclosure within which the coil 512 is shown. In some implementations, the backplate 522 may be made of a non-conductive metal or otherwise configured to conduct heat without being electrically conductive. The backplate 522 may include one or more mounting points (e.g., holes or other features) that provide for mounting the backplate 522 and the pad 500 as a whole to any surface. For example, the pad 500 may be installed on a bottom of a vehicle (e.g., the vehicle 401 of FIG. 4). The housing 530 may cover and protect the components (e.g., the coil 512 and the ferrite layer 502) of the pad 500 from external factors (e.g., the environment, weather, etc.). The backplate 522 and the housing 530 may include multiple mounting points or features that are aligned to provide for attachment of the backplate 522 to the housing 530.

In some implementations, each of the structural components of the pad 500 may operate as a loss originator. Based on the principle of Ohm's law, the coil 512 can cause loss of power in the form of heat. Due to hysteresis and eddy currents, the ferrite layer 502 may cause power losses (e.g., at least in part due to heat). With induced currents/eddy currents, the backplate 522 may cause power losses as well (e.g., at least in part due to heat). In one implementation, the backplate 522 may comprise aluminum or other similar metallic structure. The distance 535 of the aluminum backplate 522 to the coil 512, which is a source of a time-varying magnetic field, is of the order of a few millimeters. Because of the proximity of the backplate 522 to the coil 512, the induced currents on the backplate 522 can be significant and may generate 20 to 100 W of losses in some instances, thereby reducing system efficiency and increasing complexity to dissipate the extra heat.

The backplate 522 provides several benefits when used within the pad 500. First, the backplate 522 aims to provide mechanical stability to the overall structure of the pad 500. Second, the backplate 522 may also shield ferromagnetic parts and electronic components sitting above the pad 500 (integrated electronics of the vehicle or the pad 500 when the pad 500 is a vehicle pad, for instance). Third, the backplate 522 acts as a thermal interface between the ferrite layer 502 and the body of the vehicle (not shown in this figure). The heat from the ferrite layer 502 can be dissipated through the backplate 522 to a bigger vehicle shield or cooling system (not shown in this figure). In one implementation, the pad 500 may not include the backplate 522 and may be designed to operate at lower temperatures and hence can be more efficient because of the reduced overall losses. It is desirable to reduce thermal problems in such a pad 500, especially when the heat generated by coil 512 and ferrite layer 502 cannot be dissipated to outside the pad 500. On the other hand, when the backplate 522 is included in the vehicle pad 500, the pad 500 may suffer from increased losses due to the backplate 522.

The flux generated by the coil 512 or to which the coil 512 is exposed may induce eddy currents in the backplate 522. These eddy currents may create losses in the backplate 522 (e.g., heat losses, etc.). With the ferrite layer 502 positioned between the coil 512 and the backplate 522, the ferrite layer 502 may serve to reduce the losses in the backplate 522. In such a configuration, the ferrite layer 502 may generally confine the flux generated by the coil 512 to a smaller area or volume (e.g., the area or volume between the coil 512 and the ferrite layer 502). The ferrite layer 502 may also physically block or alter or adjust a flow of the flux generated by the coil 512 from reaching or passing through the backplate 522 when the ferrite layer 502 is positioned between the coil 512 and the backplate 522. Accordingly, the emissions of the coil 512 that overlap the footprint of the ferrite layer 502 may be reduced from impacting the backplate 522. For example, the ferrite layer 502 may reduce the field emissions of the coil 512 beyond the ferrite layer 502 by 30, 40 or 50%.

As shown in the cross-section view of FIG. 5C, the footprint of the backplate 522 extends beyond the footprint of the ferrite layer 502. Thus, as shown, the footprint of the backplate 522 overlaps with the coil 512 without the ferrite layer 502 separating the backplate 522 from the coil 512. Accordingly, the ferrite layer 502 is unable to direct flux generated by the coil 512 that flows vertically from the coil 512 to the backplate 522. Additionally, since the backplate 522 and the coil 512 overlap, a distance 535 between the backplate 522 and coil 512 may be the vertical distance between the backplate 522 and the coil 512, which may correspond to a thickness of the ferrite layer 502. For example, the distance 535 may be 5 mm.

However, as shown in FIGS. 5A-5C, portions of the backplate 522 (e.g., the edges of the backplate 522) do not overlap with the ferrite layer 502 but do overlap the coil 512. Accordingly, these portions of the backplate 522 may be exposed directly to the flux generated by or to which the coil 512 is exposed without the benefit of the ferrite layer 502. Accordingly, the flux may generate eddy currents in the backplate 522 that cause the backplate 522 (at least these portions) to heat up as compared to portions of the backplate 522 that are separated from the coil 512 by the ferrite layer 502.

Thus, it is desirable to design a pad including a backplate that can provide the benefits discussed above while minimizing the power losses of power by reducing portions of the backplate 522 that are directly exposed to the coil 512. In such an implementation, the designed backplate may provide substantially all of the benefits of mechanical stability, thermal interface and reduced losses.

FIGS. 6A-6C show various views of a pad 600 as used in the wireless power transfer system 400 of FIG. 4, the pad 600 including a ferrite layer 602 with a same footprint as a footprint of a backplate 622 of the pad 600, in accordance with one implementation. FIG. 6A includes a top perspective view of the pad 600, FIG. 6B includes a bottom perspective view of the pad 600, and FIG. 6C includes a partial cross-section view of the pad 600. The pad 600 includes a backplate 622, a ferrite layer 602, a coil 612, a housing 630, and a backplate holder 632.

As shown in the top perspective view of FIG. 6A, the pad 600 (e.g., a vehicle pad) includes five specific structural components: the coil 612 disposed partially on top of and partially between the ferrite layer 602 and enclosed within an enclosure created by the back plate 622, the housing 630, and the backplate holder 632. The coil 612 may be wound about a solenoid or around a core (not shown) and may be mounted on or to the backplate 622. As shown, the coil 612 is wound in a double-D (DD) configuration with varying coil thickness and width as formed by the windings. Any other configuration of the coil 612 (e.g., quadrature (Q), QDD, etc.) may be implemented in the pad 600.

The pad 600 also includes the ferrite layer 602 that may be positioned, at least in part, between the coil 612 and the backplate 622. The ferrite layer 602 may be formed from one or more pieces of ferrite. The ferrite layer 602 may have a ferrite area corresponding to a two-dimensional area covered by the ferrite layer 602. The backplate 622 is placed in contact with or next to the ferrite layer 602, so that the ferrite layer 602 is positioned between the coil 612 and the metallic backplate 622. The backplate 622 may have a backplate area corresponding to a two-dimensional area covered by the backplate 622. In some embodiments, the backplate area of the backplate 622 may be similar in size to the ferrite layer 602. The backplate holder 632 may be made of a non-conductive material that does not generate induced eddy or other currents when exposed to the field emissions.

In some embodiments, the ferrite layer 602 may have multiple levels or layers. For example, the ferrite layer 602 may comprise a first portion where windings of the coil 612 pass over the ferrite layer 602 (for example, ferrite layer 602a) and may comprise a second portion where windings of the coil 612 pass under the ferrite layer 602 (for example, ferrite layer 602b). In some embodiments, the ferrite layer 602 may comprise cutouts or channels for the windings of the coil 612 such that there is no overlap with the ferrite layer 602 by the coil 612. In some embodiments, the coil 612 may have a coil area comprising an area encompassed or surrounded by the coil 612 and an area that the coil 612 covers. In some embodiments, the coil area may be similar in size to the ferrite layer 602. In some embodiments, the coil area may be larger than the ferrite area and/or the backplate area of the ferrite layer 602 and the backplate 622, respectively.

As shown in the bottom perspective view of FIG. 6B, the backplate 622 is shown covering only a portion of a bottom surface of the pad 600. The remainder of the bottom surface of the pad 600 includes the backplate holder 632. The housing 630 is also shown aligned with the backplate holder 632, which holds the backplate 622, to create the enclosure within which the coil 612 and the ferrite layer 602 are shown. In some implementations, the backplate 622 may be metallic or otherwise configured to conduct heat. In some implementations, the backplate 622 may sit inside a frame formed by the backplate holder 632. In other words, the backplate 622 (e.g., the footprint of the backplate 622) may be designed with physical dimensions that follow or trace substantially the footprint of physical dimensions of the ferrite layer 602. In some embodiments, the backplate holder 632 may have a holder area comprising an area encompassed by or surrounded by the coil 612 and an area that the backplate holder 632 covers. Thus, the holder area may include an area encompassed by outer edges of the backplate holder 632. With this design, the exposure of the metallic material of the backplate 622 to time-varying magnetic fields generated by the coil 612 or to which the coil 612 is exposed is minimized or eliminated, thereby reducing losses but keeping the thermal and mechanical benefits of the backplate 622. The backplate holder 632 may include one or more mounting points (e.g., holes, offsets, or other physical features) that provide for mounting the backplate 622 to the backplate holder 632. The backplate holder 632 may also include one or more mounting components used to mount the backplate 622 and the pad 600 as a whole to any surface. For example, the pad 600 may be installed on a bottom of a vehicle (e.g., vehicle 401 of FIG. 4). The housing 630 may cover and protect the components (e.g., the coil 612 and the ferrite layer 602) of the pad 600 from external factors (e.g., the environment, weather, etc.). The backplate holder 632 and the housing 630 may include multiple mounting points that are aligned to attach the backplate holder 622 to the housing 630.

As shown in the cross-section view of FIG. 6C, a footprint of the backplate 622 matches a footprint of the ferrite layer 602. Thus, as shown, the footprint of the backplate 622 does not overlap with the coil 612 without at least a portion of the ferrite layer 602 separating the backplate 622 from the coil 612. Accordingly, the backplate 622 is exposed to less direct flux generated by the coil 612 that flows vertically from the coil 512 away from the backplate 522. Additionally, since the backplate 622 and the coil 612 no longer overlap, a distance 635 between the backplate 622 and coil 612 is no longer a “vertical” distance and is increased as compared to the distance 535 of FIG. 5C. Thus, the distance 635 between the backplate 622 and the coil 612 no longer corresponds to only a thickness of the ferrite layer 602. In some implementations, the distance 635 may be 8 mm. In some embodiments, the backplate 622 may include a channel or a spacing.

As described herein, each of the structural components of the pad 600 may operate as a loss originator. However, as compared to the distance 535 of the pad 500, the distance 635 of the backplate 622 to the coil 612 is larger in the order of a few millimeters. Because of the reduced proximity of the backplate 622 to the coil 612 as compared to the proximity of the backplate 622 to the coil 612 and because of the reduced overlap of the backplate 622 and the coil 612 as compared to the overlap of the backplate 522 and the coil 512, the induced currents on the backplate 622 may be significantly less than the induced currents on the backplate 522, resulting in reduced losses in some instances. Accordingly, the pad 600 provides improved system efficiency and may result in reduced complexity to dissipate the heat as compared to the pad 500.

The backplate 622 may provide similar benefits as the backplate 522 of FIGS. 5A-5C.

The backplane 622 provides several benefits when used with in the pad 600. First, the backplate 622 may provide mechanical stability to the overall structure of the pad 600. Second, the backplate 622 may also shield ferromagnetic parts and electronic components sitting directly above the pad 600 (integrated electronics of the vehicle or the pad 600 when the pad 500 is a vehicle pad, for instance). Third, the backplate 622 acts as a thermal interface between the ferrite layer 602 and the body of the vehicle (not shown in this figure).

The flux generated by the coil 612 or to which the coil 612 is exposed may induce eddy currents in the backplate 622. However, as there are no portions of the backplate 622 that are directly exposed to the coil 612, the eddy currents induced in the backplate 622 that create losses in the backplate 622 may be reduced. Since the ferrite layer 602 is positioned between the coil 612 and the backplate 622 for generally all configurations of the pad 600, the ferrite layer 602 may serve to reduce the losses in the backplate 622. In such configurations, the ferrite layer 602 may generally confine the flux generated by the coil 612 to a smaller area or volume (e.g., the area or volume between the coil 612 and the ferrite layer 602). Furthermore, the increased distance 635 of direct exposure between the backplate 622 and the coil 612 as compared to the distance 535 may result in further reduced losses generated in the backplate 622. Furthermore, as the backplate holder 632 may be formed from plastic, which is non-conductive, the flux generated by the coil 612 may not induce any eddy currents in the backplate holder 632, which means that no heat losses may be generated in the backplate holder 632. Thus, the pad 600 including the backplate 622 having the footprint that matches and overlaps the footprint of the ferrite layer 602 may provide the benefits discussed above while minimizing the power losses in the backplate 622. In such an implementation, the designed backplate may provide substantially all of the benefits of mechanical stability, thermal interface and reduced losses. In some implementations, the backplate 622 may comprise two (or more) separate pieces that are positioned with a channel or spacing between them. In some embodiments, the channel or spacing between the pieces of the backplate 622 may align with overlap of the coil 612 such that there are no portions of the backplate 622 that overlap with any portion of the coil 612, even with the ferrite layer 602 separating them. Such a configuration of reduced overlap of the coil 612 and the backplate 622 may further reduce losses generated in the backplate 622.

FIG. 7 shows an exploded perspective view of the pad 600 of FIGS. 6A-6C, in accordance with one implementation. As shown in FIG. 7, a base or bottom layer of the pad 600 may include the backplate holder 632. The backplate holder 632 may include an opening within which the backplate 622 is placed. In some implementations, the backplate holder 632 may include a lip or other formed edge around the opening that interfaces with a corresponding lip or formed edge on the backplate 622. When the backplate 622 is placed within the opening of the backplate holder 632, top surfaces of the backplate 622 and the backplate holder 632 may be substantially coplanar. In some implementations, the backplate 622 may have a top surface that is lower or below a top surface of the backplate holder 632 when the backplate 622 is placed within the opening of the backplate holder 632.

The ferrite layer 602 is positioned above the backplate 622, such that a bottom surface of the ferrite layer 602 is in contact with the top surface of the backplate 622. Thus, the bottom surface of the ferrite layer 602 may be at or above the top surface of the backplate holder 632 or below the top surface of the backplate holder 632. In some implementations, as shown in FIG. 7, the ferrite layer 602 may comprise two separate pieces of ferrite that are positioned with a channel between them.

The coil 612 may be positioned in contact with the ferrite layer 602. For example, the coil 612 may be found in the DD coil such that inner and adjacent windings of the DD coil are in contact with a top surface of the ferrite layer 602. Outer windings of the DD coil may be stacked such that they are in contact with edge surfaces of the ferrite layer 602. Accordingly, the windings of the coil 612 may not be parallel with the top surface of the ferrite layer 602. In some implementations, leads for the coil 612 may be positioned or disposed in the channel between the pieces of the ferrite layer 602. The housing 630 may be positioned above the coil 612 and may include sides or edges that extend below a top surface of the housing 630. The sides of the housing 630 may extend to contact the backplate holder 632 such that the housing 630, the backplate 622, and the backplate holder 632 together form an enclosure within which the coil 612 and the ferrite layer 602 are disposed.

FIGS. 8A and 8B show an image 800a depicting losses due to induced currents in the backplate 522 of the pad 500 of FIGS. 5A-5C as compared to an image 800b depicting losses due to induced currents in the backplate 622 of the pad 600 of FIGS. 6A-6C, in accordance with one implementation. Specifically, the image 800a shows the losses of the backplate 522 while the pad 500 is being used to generate a wireless field or to transfer wireless power, while the image 800b shows the losses of the backplate 622 while the pad 600 is being used to generate a wireless field or to transfer wireless power.

As described herein and shown in FIGS. 5A-5C, the footprint of the backplate 522 of the pad 500 overlaps with the coil 512 such that there is a portion of the backplate 522 that is directly exposed to the coil 512. Such direct exposure (in conjunction with the reduced distance 535 between the backplate 522 and the coil 512) results in increased eddy currents the portions of the backplate 522 that overlap with the coil 512 (e.g., the edges of the backplate 522). The increased eddy currents result in increased losses at the edges of the backplate 522, shown in FIG. 8A as portions 802a. Losses for the portions 802a of the backplate 522 during operation of the pad 500 may approach 1500 W/m². Portions 804a of the backplate 522 represent portions of the backplate 522 that overlap with the ferrite layer 502. Losses for these portions 802b of the backplate 522 during operation of the pad 500 may be closer to 1 W/m². Thus, the exposed portions of the backplate 522 result in exponentially more power loss in the backplate 522 as compared with the portions of the backplate 522 that overlap with the ferrite layer 502.

In contrast, the footprint of the backplate 622 of the pad 600 does not overlap with the coil 612 without any intervening portion of the ferrite layer 602. Instead, the backplate holder 632 may overlap with the coil 612 and may be exposed to the coil 612. However, since the backplate holder 632 is generally non-metallic, the exposure of the backplate holder 632 to the coil 612 does not generate any (or generates minimal or negligible) eddy currents in the backplate holder 632 and thus does not generate any (or generates minimal or negligible) losses in the backplate holder 632. Accordingly, losses for the portions 802b, corresponding to the overlapping backplate holder 632 and the coil 612 with no intervening ferrite layer 602, during operation of the pad 600 may be non existent, minimal, or negligible. Portions 804b of the backplate 622 represent portions of the backplate 622 that overlap with the ferrite layer 602 and the coil 612. Losses for these portions 804b of the backplate 622 during operation of the pad 600 may be approximately 1 W/m². Thus, the application of the backplate holder 632 in the pad 600 greatly reduces total losses in the pad 600 (e.g., 0 W/m2 (for portion 804a)+1 W/m2 (for portion 804b)=1 W/m2 total losses in pad 600) as compared to total losses of the pad 500 (e.g., 1500 W/m2 (for portion 802a)+1 W/m2 (for portion 802b)=1501 W/m2 total losses in pad 500).

FIG. 9 shows a flowchart for a method 900 of transferring wireless power using a pad (for example, the vehicle pad of FIGS. 6A-6C), in accordance with one implementation. In some embodiments, the various blocks shown in the method 900 may be performed as part of a wireless power charging process. According, one or more of the blocks shown in method 900 may be performed by one of the transmitter 104, 204, and 404 or the receiver 108, 208, and 408 of FIGS. 1, 2, and 4. In some embodiments, one or more of the blocks shown may be omitted from or additional blocks may be added to the method 900 shown. In some embodiments, one or more blocks of the method 900 may be performed by other components of a wireless power transfer system 100, 200, or 400. The method 900 begins at block 902. At block 904, a magnetic field is generated over a charging area using a transmit antenna circuit. In some embodiments, the transmit antenna circuit may comprise one or more coil antennas. In some embodiments, the transmit antenna coil may be disposed in a double-D configuration.

At block 906, at least a portion of the magnetic field may be altered using a ferrite material. In some embodiments, the ferrite material may be positioned in contact with or next to and/or below at least a portion of the transmit antenna circuit. In some embodiments, the ferrite material may have a ferrite footprint forming a two-dimensional ferrite area.

At block 908, one or more components other than the transmit antenna circuit and the ferrite material may be shielded from the magnetic field via a metallic plate. In some embodiments, the metallic plate may be positioned in contact with or next to and/or below the ferrite material. In some embodiments, the metallic plate may have a footprint forming an area that is substantially equal to the two-dimensional area of the ferrite footprint. In some embodiments, the metallic plate may be positioned to substantially overlap the ferrite material.

At block 910, the method 900 ends.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

For example, a first means for generating a magnetic field over a charging area may comprise a coil or similar antenna (e.g., coil 512). The first means for generating a magnetic field may perform block 904 of method 900. A means for modifying the magnetic field may comprise a ferrite material or similar structure (for example, ferrite layer 502). The means for modifying the magnetic field may perform block 906 of method 900. A means for supporting the means for modifying and the means for generating the magnetic field may comprise a shield or similar structure (for example, the backplate 522). The means for supporting the means for modifying and the means for generating the magnetic field may perform block 908 of method 900.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions may not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An apparatus for wireless power transfer, comprising:
a coil configured to generate a magnetic field over a charging area, the coil forming a coil area;
a ferrite material positioned in contact with or next to the coil, the ferrite material having a ferrite footprint forming a two-dimensional area, the two-dimensional area at least partially overlapping the coil area; and
a metallic plate positioned in contact with or next to the ferrite material, the metallic plate having a footprint forming an area that is substantially equal to and overlapping the two-dimensional area of the ferrite footprint.

2. The apparatus of claim 1, wherein the coil comprises a conductor arranged in a double-D coil configuration that is disposed, at least in part, on top of the ferrite material.

3. The apparatus of claim 2, wherein the coil area is larger than the two-dimensional area of the ferrite material and the area of the metallic plate.

4. The apparatus of claim 2, wherein the metallic plate comprises two metallic portions disposed having a channel therebetween, wherein the channel aligns with a portion of the coil that overlaps the ferrite material.

5. The apparatus of claim 1, further comprising a non-conductive holder positioned in contact with or next to the metallic plate, the non-conductive holder positioned to frame the metallic plate.

6. The apparatus of claim 1, wherein the coil and the metallic plate are positioned such that there is no overlap between the coil and the metallic plate.

7. The apparatus of claim 1, wherein the ferrite material comprises two ferrite portions disposed having a channel therebetween, wherein the channel provides a path for one or more leads of the coil.

8. The apparatus of claim 1, wherein a distance between the coil and a non-overlapping portion of the metallic plate is greater than a thickness of the ferrite material.

9. The apparatus of claim 1, further comprising a housing aligned with the metallic plate that creates an enclosure within which the coil is disposed and configured to protect the coil and the ferrite material from external factors.

10. An apparatus for wireless power transfer, comprising:
means for generating a magnetic field over a charging area;
means for modifying the magnetic field positioned below the generating means, the modifying means having a ferrite footprint forming a two-dimensional area; and
means for supporting the modifying means and the generating means, the supporting means positioned below and substantially overlapping the modifying means such that the modifying means is positioned between and separating the generating means and the supporting means, the supporting means having a footprint forming an area that is substantially equal to the two-dimensional area of the ferrite footprint.

11. The apparatus of claim 10, wherein the generating means comprises a conductor arranged in a double-D coil configuration that is disposed, at least in part, on top of the modifying means.

12. The apparatus of claim 11, wherein the coil area is larger than the two-dimensional area of the modifying means and the area of the supporting means.

13. The apparatus of claim 11, wherein the supporting means comprises two metallic portions disposed having a channel therebetween, wherein the channel aligns with a portion of the generating means that overlaps the modifying means.

14. The apparatus of claim 10, further comprising a non-conductive holder positioned in contact with or next to the supporting means, the non-conductive holder positioned to frame the supporting means.

15. The apparatus of claim 10, wherein the generating means and the supporting means are positioned such that there is no overlap between the generating means and the supporting means.

16. The apparatus of claim 10, wherein the modifying means comprises two ferrite portions disposed having a channel therebetween, wherein the channel provides a path for one or more leads of the generating means.

17. The apparatus of claim 10, wherein a distance between the generating means and a non-overlapping portion of the supporting means is greater than a thickness of the modifying means.

18. The apparatus of claim 10, further comprising a housing aligned with the supporting means that creates an enclosure within which the generating means and the modifying means are disposed and configured to protect the generating means and the modifying means from external factors.

19. A method of transferring wireless power, the method comprising:
generating a magnetic field over a charging area via a transmit antenna circuit;
altering at least a portion of the magnetic field using a ferrite material positioned below at least a portion of the transmit antenna circuit, the ferrite material having a ferrite footprint forming a two-dimensional area; and
shielding components other than the transmit antenna circuit and the ferrite material from the magnetic field via a metallic plate positioned below and substantially overlapping the ferrite material such that the ferrite material is positioned between and separating the transmit antenna circuit and the metallic plate, the metallic plate having a footprint forming an area that is substantially equal to the two-dimensional area of the ferrite footprint.

20. The method of claim 19, wherein the transmit antenna circuit comprises a conductor arranged in a double-D coil configuration that is disposed, at least in part, on top of the ferrite material.

21. The method of claim 20, wherein the transmit antenna circuit has a coil area that is larger than the area of the ferrite material and the area of the metallic plate.

22. The method of claim 20, wherein the metallic plate comprises two metallic portions disposed having a channel therebetween, wherein the channel aligns with a portion of the transmit antenna circuit that overlaps the ferrite material and provides for reduced overlap of the transmit antenna circuit and the metallic plate.

23. The method of claim 19, wherein the metallic plate is framed by a non-conductive holder.

24. The method of claim 19, wherein the transmit antenna circuit and the metallic plate are positioned such that there is no overlap between the transmit antenna circuit and the metallic plate.

25. The method of claim 19, wherein the ferrite material comprises two ferrite portions disposed having a channel therebetween, wherein the channel provides a path for one or more leads of the transmit antenna circuit.

26. The method of claim 19, wherein a minimum distance between the transmit antenna circuit and a non-overlapping portion of the metallic plate is greater than a minimum thickness of the ferrite material.

27. The method of claim 19, wherein the transmit antenna circuit and the ferrite material as disposed within an enclosure formed between the metallic plate and a housing aligned with the metallic plate and wherein the housing is configured to protect the transmit antenna circuit and the ferrite material from external factors.

28. A method of forming an apparatus for wireless power transfer, the method comprising:
positioning a coil having a coil area and configured to generate a magnetic field over a charging area in contact with or next to a ferrite material, the ferrite material having a ferrite footprint forming a two-dimensional area, the two-dimensional area at least partially overlapping the coil area; and
positioning a metallic plate in contact with or next to the ferrite material, the metallic plate having a footprint forming an area that is substantially equal to and overlapping the two-dimensional area of the ferrite footprint.

29. The method of claim 28, wherein the coil comprises a conductor arranged in a double-D coil configuration that is disposed, at least in part, on top of the ferrite material.

30. The medium of claim 29, wherein the coil area is larger than the two-dimensional area of the ferrite material and the area of the metallic plate.
